(19) United States
(12) Patent Application Publication
(10) Pub. No.: US 2020/0085027 A1
(43) Pub. Date: Mar. 19, 2020

(54) Fishing Rod Caddy

(71) Applicant: Castek, Inc., Springville, UT (US)

(72) Inventors: Ryan Crawford, Salem, UT (US); Chris Nelson, Provo, UT (US); Richard Smith, Spanish Fork, UT (US)

(73) Assignee: Castek, LLC.

(21) Appl. No.: 16/567,878

(22) Filed: Sep. 11, 2019

Related U.S. Application Data
(60) Provisional application No. 62/731,241, filed on Sep. 14, 2018.

(51) Int. Cl. A01K 97/08; A01K 97/10

(52) U.S. Cl. CPC A01K 97/08; A47B 81/005; A01K 97/10

(57) ABSTRACT

The invention provides a fishing rod caddy to display, transport and support fishing rods. The caddy comprises an array of receivers carried by a frame, and each sized and shaped to receive a fishing rod. At least one leg is carried by the frame and is pivotal with respect to the frame between a retracted orientation adjacent the frame and a deployed orientation extending from the frame configured to orient the frame at an incline with respect to horizontal. An automatic deployment mechanism is carried by the frame and is operatively coupled to the at least one leg to automatically deploy the at least one leg to the deployed orientation.

### PRIORITY CLAIM

Priority is claims to U.S. Provisional Patent Application Ser. No. 62/731,241, filed Sep. 14, 2018, which hereby incorporated herein by reference.

### BACKGROUND

### Field of the Invention

The present invention relates generally to fishing gear. More particularly, the present invention relates to a fishing rod caddy for fishing rods.

### Related Art

Fishing is a popular sport enjoyed by many. Fishing poles can be long and difficult to transport. Various carriers have been proposed, but can still be awkward to use. In addition, fishing poles and activity in the sport can be a source of pride for those involved. Various racks have been proposed to display poles on walls, but do not lend themselves to being transported. Furthermore, holding a fishing pole while fishing can be monotonous and can strain a user's hands. Various pole mounts have been proposed.

### SUMMARY OF THE INVENTION

The invention provides a fishing rod caddy to carry fishing rods. The caddy comprises an array of receivers carried by a frame, and each sized and shaped to receive a fishing rod. At least one leg is carried by the frame and is pivotal with respect to the frame between a retracted orientation adjacent the frame and a deployed orientation extending from the frame configured to orient the frame at an incline with respect to horizontal. An automatic deployment mechanism is carried by the frame and is operatively coupled to the at least one leg to automatically deploy the at least one leg to the deployed orientation. The automatic deployment mechanism comprises a foot pivotally coupled to the frame at a bottom thereof, and a link coupled to and between the foot and the at least one leg near a top thereof. The foot pivots when the frame is placed on a surface and tilted backwards, displacing the link and causing the at least one leg to pivot to the deployed orientation.

In accordance with a more detailed aspect of the invention, the array of receivers can be arranged in a broad arc with distal ends of the broad arc located adjacent the opposite lateral sides of the frame. A concavity can be defined by the broad arc. The at least one leg can be substantially enclosed in the concavity of the broad arc when the at least one leg is in the retracted orientation. The automatic deployment mechanism can be substantially enclosed in the concavity of the broad arc when the at least one leg is in the retracted orientation.

In addition, the invention provides a fishing rod caddy to carry fishing rods. The caddy comprises a frame with a base and a top rib spaced-apart from the base. An array of receivers is carried by the frame and each is sized and shaped to receive a fishing rod. Each receiver comprises a slot in the top rib and a pair of pockets located adjacent one another in the base. The pair of pockets corresponds to and is substantially aligned with the slot in the top rib. The slot is sized and shaped to receive both butt and tip portions of the fishing rod when the shaft of the fishing rod is separated at a ferrule into the butt and tip portions and doubled back on one another. The pair of pockets comprise a handle pocket and a tip pocket. The handle pocket is sized and shaped to receive a handle of the fishing rod. The tip pocket is sized and shaped to receive a tip of the fishing rod.

Furthermore, the invention provides a fishing rod caddy to carry fishing rods. The caddy comprises a pair of hangers to be disposed between and intercoupling a frame and a support surface to suspend the frame pendent from the support surface. Each hanger comprises at least one notch to be secured to the support surface and comprising a pocket with a narrower slot open to an enlarged cavity. At least one lug extends from the frame with an enlarged head spaced-apart from the frame by a narrower neck, and being removably receivable in the at least one notch with the narrower slot receiving the neck of the lug and the enlarged cavity receiving the head the lug. The enlarged head of the at least one lug extending beyond the at least one leg. The pair of hangers is positioned to selectively orient the array of receptacles, and configured to selectively orient the fishing rods, in a vertical orientation, or a horizontal orientation, or at an acute incline.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a front, top perspective view of a fishing rod caddy in accordance with an embodiment of the invention.

FIG. 2 is a front, bottom perspective view of the fishing rod caddy of FIG. 1.

FIG. 3 is a rear, top perspective view of the fishing rod caddy of FIG. 1, showing a pair of legs in a retracted orientation.

FIG. 4 is a rear, bottom perspective view of the fishing rod caddy of FIG. 1, showing the pair of legs in the retracted orientation.

FIG. 5 is a front view of the fishing rod caddy of FIG. 1.

FIG. 6 is a side view of the fishing rod caddy of FIG. 1, shown removed from a pair of notches in accordance with an embodiment of the invention.

FIG. 7 is a top view of the fishing rod caddy of FIG. 1.

FIG. 8 is a rear view of the fishing rod caddy of FIG. 1.

FIG. 9 is a side view of the fishing rod caddy of FIG. 1.

FIG. 10 is a bottom view of the fishing rod caddy of FIG. 1.

FIG. 11 is a top view of the fishing rod caddy of FIG. 1, showing slots in a top rib and receiving both butt and tip portions of a fishing rod with the shaft of the fishing rod separated at a ferrule into the butt and tip portions and doubled back on one another in the slots.

FIG. 12 is a cross-sectional top view of the fishing rod caddy of FIG. 1, taken along line 12 of FIG. 8, showing a pair of pockets, including a handle pocket and a tip pocket, in a base and with the handle pocket receiving a handle of the fishing rod and the tip pocket receiving a tip of the fishing rod with the shaft of the fishing rod separated at the ferrule into the butt and the tip portions and doubled back on one another.

FIG. 13 is a bottom view of the fishing rod caddy of FIG. 1.

FIG. 14 is a partial top perspective view of the fishing rod caddy of FIG. 1, showing the slots in the top rib and receiving both butt and tip portions of the fishing rod with the shaft of the fishing rod separated at the ferrule into the butt and tip portions and doubled back on one another in the slots.

FIG. 15 is a partial top perspective view of the fishing rod caddy of FIG. 1, showing the pair of pockets, including the handle pocket and the tip pocket, in the base and with the handle pocket receiving the handle of the fishing rod and the tip pocket receiving the tip of the fishing rod with the shaft of the fishing rod separated at the ferrule into the butt and the tip portions and doubled back on one another.

FIG. 16 is a front perspective view of the fishing rod caddy of FIG. 1, showing the pair of legs in a deployed orientation.

FIG. 17 is a rear perspective view of the fishing rod caddy of FIG. 1, showing the pair of legs in the deployed orientation.

FIG. 18 is a rear, side perspective view of the fishing rod caddy of FIG. 1, showing the pair of legs in the deployed orientation.

FIG. 19 is a side perspective view of the fishing rod caddy of FIG. 1, showing the pair of legs in the deployed orientation.

FIG. 20 is a front view of the fishing rod caddy of FIG. 1, showing a plurality of fishing rods therein, and showing the pair of legs in the retracted orientation, and removed from the pair of notches.

FIG. 21 is a front, side perspective view of the fishing rod caddy of FIG. 1, showing the plurality of fishing rods therein, and showing the pair of legs in the deployed orientation.

FIG. 22 is a partial top perspective view of the fishing rod caddy of FIG. 1, showing a top plate for securing the fishing rod caddy and frame thereof to a backpack.

FIG. 23 is a partial top perspective view of the fishing rod caddy of FIG. 1, showing a clamp for securing the fishing rod caddy and frame thereof to the backpack.

FIG. 24 is a partial bottom perspective view of the fishing rod caddy of FIG. 1, showing a clamp and a bottom plate for securing the fishing rod caddy and frame thereof to the backpack.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

Before invention embodiments are disclosed and described, it is to be understood that no limitation to the particular structures, process steps, or materials disclosed herein is intended, but also includes equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in the specification, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility to a numerical range endpoint by providing that a given value may be “a little above” or “a little below” the endpoint. It is understood that express support is intended for exact numerical values in this specification, even when the term “about” is used in connection therewith.

The terms “interference fit” and “friction fit” and “press-fit” are terms of art used interchangeably herein to refer to deliberately causing, increasing and/or using friction to deliberately resist movement. An interference fit or friction fit is different than and great than the existence of friction. While friction may exist between any two surfaces, is often desirable to do all one can to reduce this friction. An interference fit or friction fit can be distinguished from naturally occurring friction by being actually deliberately caused and increased. An interference fit can be created by dimensioning engaging parts so that their surfaces tightly bear against one another. A friction fit can be created by surface roughness that is rougher.

The terms “rod” and “pole” are used interchangeably herein. A fishing rod can have an elongated blank or shaft with an array of guides spaced-apart along a length thereof. A handle can be formed at a proximal end of the rod with a distal end can have a tip. A reel with fishing line can be coupled to a reel seat near the handle. The blank or shaft can be separated into two portions, namely butt and tip portions, and joined together and separable at a ferrule.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, sizes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment. Furthermore, the described features, structures, or characteristics may be combined in any suitable manner in one or more embodiments. In this description, numerous specific details are provided, such as examples of layouts, distances, network examples, etc. One skilled in the relevant art will recognize, however, that many variations are possible without one or more of the specific details, or with other methods, components, layouts, measurements, etc. In other instances, well-known structures, materials, or operations are not shown or described in detail but are considered well within the scope of the disclosure.

### Example Embodiments

An initial overview of technology embodiments is provided below and specific technology embodiments are then described in further detail. This initial summary is intended to aid readers in understanding the technology more quickly but is not intended to identify key or essential features of the technology nor is it intended to limit the scope of the claimed subject matter.

A fishing rod caddy is presented to display, transport and support fishing rods. The caddy can provide a rack, a carrier and a stand for the fishing rods. The caddy provides a frame for holding and securing fishing rods, and for being removably mounted on various surfaces and/or objects, including a wall, a ceiling, a trunk of a vehicle, a bed of a vehicle or truck, a boat, a backpack, a tackle box, a cooler or ice chest, or the like. In addition, the frame, and thus the fishing rods, can be mounted in various orientations, including a vertical, a horizontal or an inclined orientation. Thus, the frame can provide a rack to hold and even display the fishing rods in an organized and safe manner. In addition, the fishing rods can be secured to the frame so that the fishing rods can be displaced or transported using the frame as a carrier. Furthermore, the frame can have deployable legs to present the frame at an incline as a stand to hold the fishing rods at an incline during use. In another aspect, the frame is configured to hold and secure fishing rods that have been broken-down, or separated at a mid-point and doubled back over, to reduce the length suitable for storage in a smaller space, such as the trunk of a car.

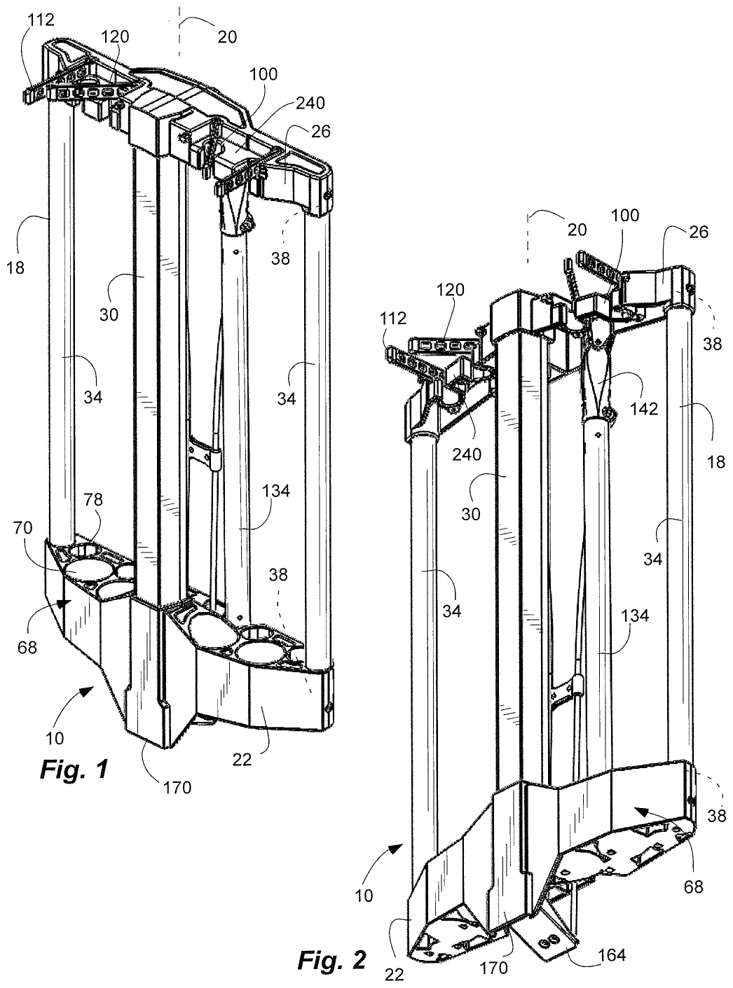

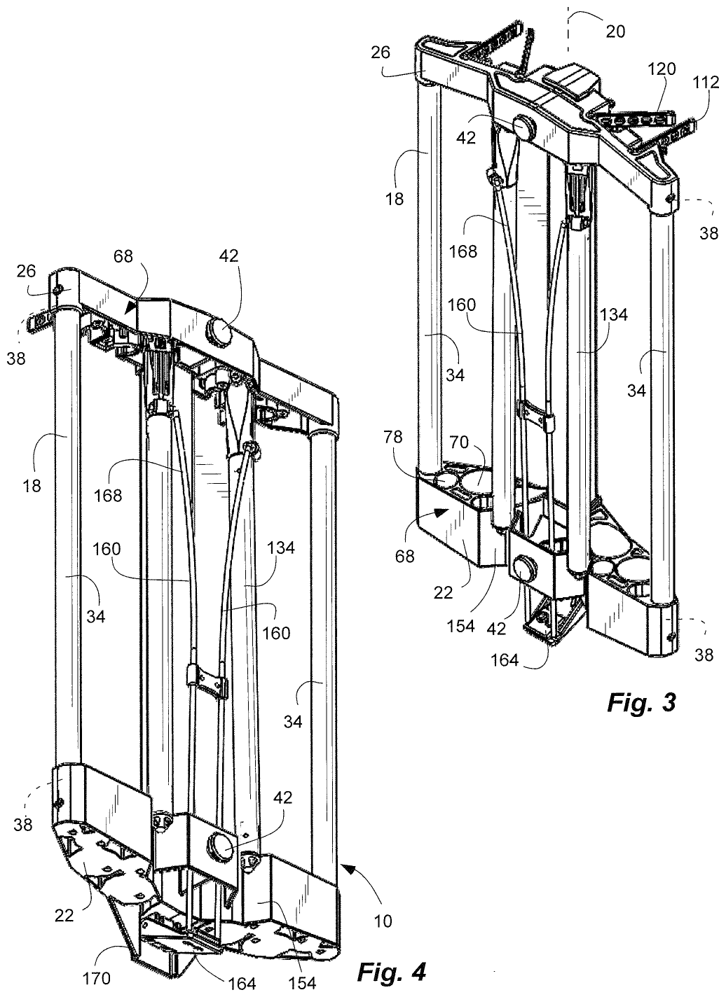

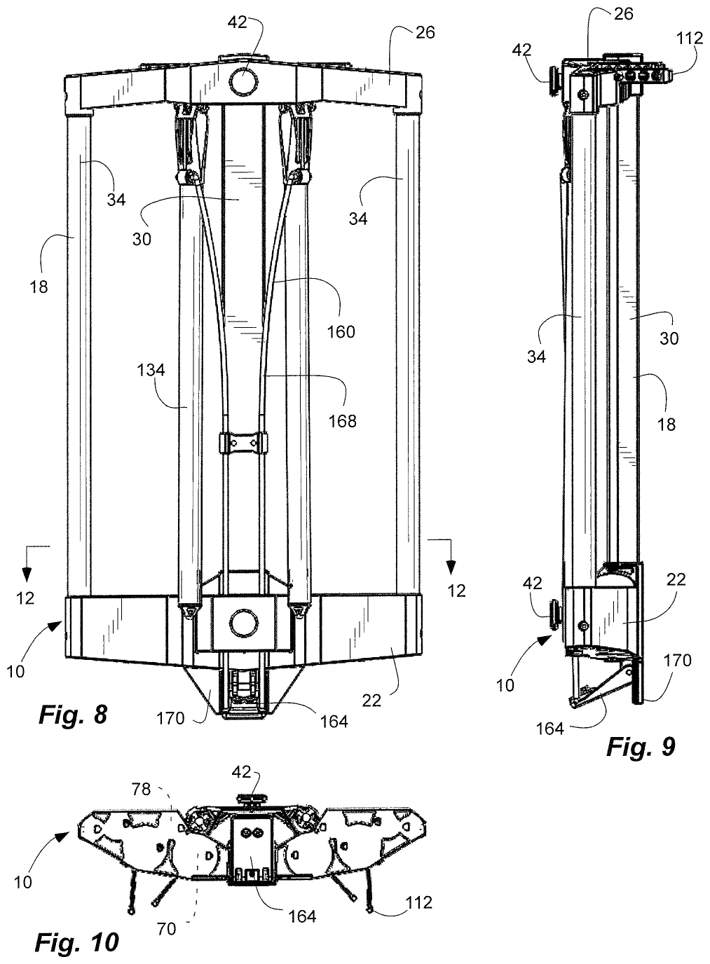

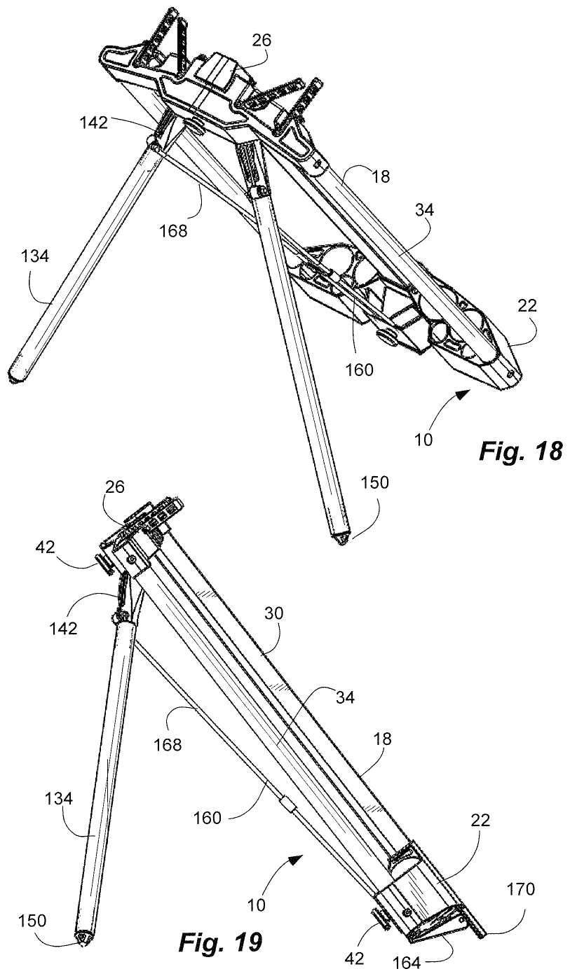

As illustrated in FIGS. 1-20, a fishing rod caddy 10 in accordance with the invention is shown for displaying, transporting and supporting fishing rods 14. As described above, the caddy 10 can receive multiple fishing rods 14 in a secure manner for transportation. In addition, the caddy 10 can organize the fishing rods 14. In addition, the caddy 10 can be mounted and carried on various different support surfaces and in various different orientations. In addition, the caddy 10 can present the fishing rods 14 for display.

The caddy 10 comprises a frame 18 to hold and secure the fishing rods 14. The frame 18 has a longitudinal axis 20 generally aligned with a length of the fishing rods 14 carried by the frame 18, and opposite lateral sides. The frame 18 can have a base 22, or a bottom rib, and a top rib 26 spaced-apart from the base 22 and intercoupled by one or more members. The frame 18 can have an elongated center spine 30 extending between and coupled to the base 22 and the top rib 26. The base 22 can be located at a bottom end of the spine 30, and can extend laterally from the spine 30. The top rib 26 can be located at a top end of the spine 30, and can be spaced-apart from the base 22. Similarly, the top rib 26 can extend laterally from the spine 30, and can be laterally aligned with respect to the base 22. In addition, a pair of lateral spars 34 can extend along the lateral sides of the frame, and between the lateral sides of the base 22 and the top rib 26. The spars 34 can be oriented substantially parallel with each other and the spine 30. The base 22 and the top rib 26 can have matching and opposing bores 38 receiving opposite ends of the spine 30 and the pair of spars 34. In one aspect, the base 22 and the top rib 26 can be formed of plastic, and can be formed by injection molding. In another aspect, the spine 30 and the spars 34 can be formed of metal, and can be formed by extruding. In one aspect, the spine 30 can have a non-circular cross-section shape, such as square or polygonal, to resist twisting or misalignment between the base 22 and the top rib 26. In another aspect, the spars 34 can have a circular cross-sectional shape. Thus, the spars 34 can define handles and grips to carry the frame 18 with the fishing rods 14. Similarly, the spine 30 can define a handle and grip to carry the frame 18, and thus the fishing rods 14. The spine 30 and the spars 34 can be formed of metal tubing. A distance between the base 22 and the top rib 26 can be sized to receive the handle 74 and the reel 184 of the fishing rod 14 therebetween. A width of the frame 18, and thus the base 22 and the top rib 26, between the lateral sides can be sized to receive multiple fishing rods therebetween. In one aspect, the frame 18 and the width can be sized to receive four fishing rods with reels.

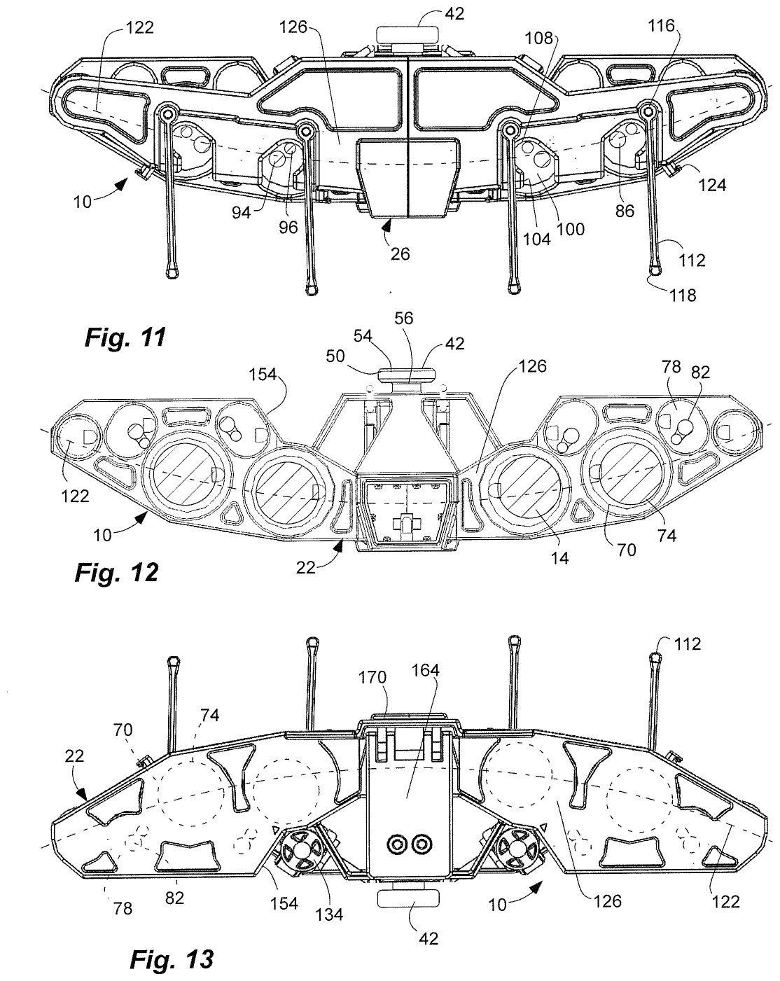

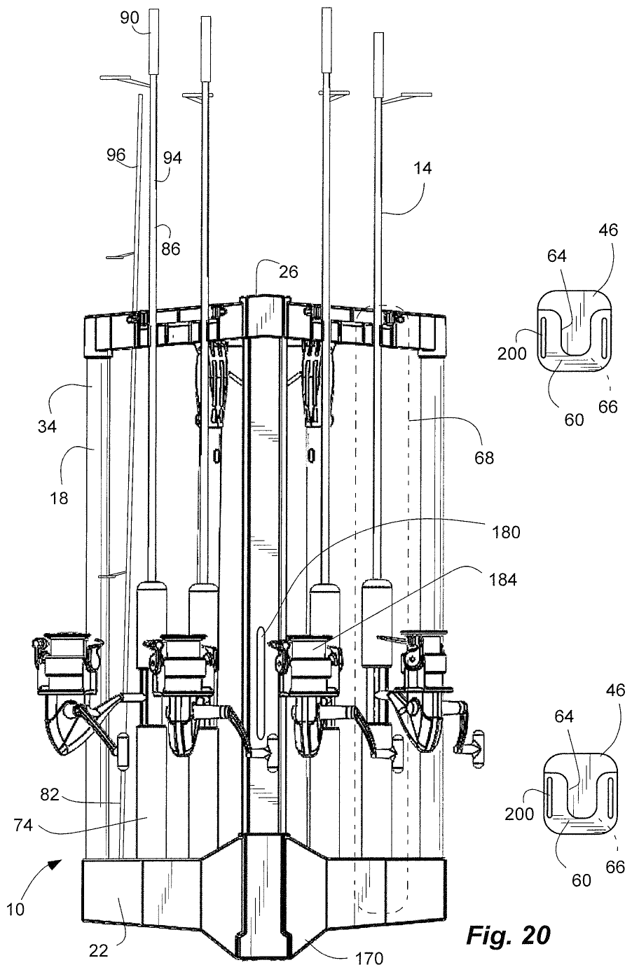

The caddy 10 and the frame 18 can also have at least one hanger, such as a pair of hangers 42, carried by the frame 18 to suspend the frame 18 pendent from the hanger 42. The hangers 42 can be located on a back of the frame 18 and can extend from the frame 18. The hangers 42 can mate with a corresponding notch 46 (FIGS. 6 and 20) or pair of notches secured to a support surface, such as those described above. Each hanger 42 can comprise a lug 50 with an enlarged head 54 spaced-apart from the frame 18, the base 22 and the top rib 26, by a narrower neck 56, as shown in FIGS. 11-13. Each of the notches 46 can comprise a pocket 60 with a narrower slot 64 open to an enlarged cavity 66, as shown in FIG. 20. The narrower slot 64 can receive the neck 56 of a corresponding lug 50, and the enlarged cavity 66 can receive the head 54 of the corresponding lug 50. The notches 46 can be affixed to the support surface, such as by adhesive or fasteners. In one aspect, the notches 46 can be vertically aligned to oriented the frame 18, and thus the fishing poles 14, vertically, such as on a wall, as shown in FIG. 20. In another aspect, the notches 46 can be inclined with respect to one another to orient the frame 18, and thus the fishing poles 14, at an incline, such as on a wall. In another aspect, the notches 46 can be horizontally aligned with respect to one another to orient the frame 18, and thus the fishing poles 14, horizontally, such as on a ceiling. The notches 46 can be affixed to other objects, such as a cooler or backpack, to mount the frame 18, and thus the fishing poles 14, thereto. The notches 46 can be formed of plastic, and can be formed by injection molding. In one aspect, the notches 46 can have an adhesive backing to be affixed to the support surface or the object. In another aspect, the notches 46 can have apertures to receive fasteners therethrough. The notches 46 can removably receive the hangers 42 so that the caddy 10, the frame 18 and the fishing rods 24 can be removably mounted to the support surface, such as the wall. Thus, the caddy 10 with the fishing rods 14 can be readily removed and transported for use. In one aspect, the notches 42 and the notches 46 can have, or can form, a press-fit or interference-fit therebetween.

In addition, the caddy 10 and the frame 18 can have an array of receivers 68 carried by the frame 18, with each receiver 68 sized and shaped to receive a fishing rod 14. In addition, the receivers 68 can be configured to receive a fishing rod 14 that is broken-down, namely with the shaft 86 of the fishing rod separated at a ferrule 90 into butt and tip portions 94 and 96 and doubled back on one another, and even with fishing line in guides thereof. The receivers 68 can be formed in both the base 22 and the top rib 26. Thus, the receivers 68 can be formed by two portions, spaced-apart from one another and split between the base 22 and the top rib 26, but aligned with one another and interconnected by the center spine 30 and the lateral spars 34. In another aspect, the receivers 68, the frame 18 and the caddy 10 can be open so that the rods 14, the reels and the handles can be exposed for display.

Each receiver 68 can include at least one pocket in the base 22. The at least one pocket can be sized and shaped to receive a handle 74 of the fishing rod and a tip 82 of the fishing rod 14 when the shaft 86 of the fishing rod is broken-down, of is separated at the ferrule 90 into butt and the tip portions 94 and 96 and doubled back on one another. In one aspect, the at least one pocket can comprise a pair of pockets 70 and 78 or receptacles located adjacent one another in the base 22. The pockets 70 and 78 can be formed in the base 22 and open upwardly towards the top rib 26 when the caddy 10 and the frame 18 are oriented horizontally. The pair of pockets 70 and 78 includes a handle pocket 70 and a tip pocket 78. The handle pocket 70 can be sized and shaped to removably receive the handle 74 of a fishing rod 14, as shown in FIG. 12. The handle pocket 70 can have a bottom to receive and support the weight of the fishing rod 14, and lateral walls entirely or substantially circumscribing the handle 74 to resist lateral displacement. Each tip pocket 78 can be paired with a different one of the handle pockets 70, and each tip pocket 78 can be located adjacent to a corresponding handle pocket 70. The tip pocket 78 can be sized and shaped to receive the tip 82 of a corresponding fishing rod 14, including the guide thereof, adjacent the handle 74 thereof. In one aspect, the tip pocket 78 can be sized and shaped to receive more than one tip 82, such as a pair of tips 82. Thus, one tip pocket 78 can be associated with two handle pockets 70, or the receiver 68 can accommodate a rod 14 with two separate tips 82. In one aspect, the handle and tip pockets 70 and 78 can be separate and discrete pockets, separated from one another by their respective walls or sides. In another aspect, the handle and tip pockets 70 and 78 can be combined, such as with an interconnecting channel or overlapping shapes for a more compact design. The pair of pockets 70 and 78 adjacent one another in the base 22 allows both the tip 82 and the handle 74 of the fishing rod 14 to be received and retained when the rode 14 is broken-down; and thus allows the caddy 10 to transport rods 14 broken-down for ease of transportation, particularly in limited space, such as a trunk of a vehicle.

In addition, each receiver 68 can include a slot 100 in the top rib 26. The slot 100 can be formed in the top rib 26, and can extend through a top and a bottom of the top rib 26, and thus can be open longitudinally. Each slot 100 in the top rib 26 can correspond to and be substantially aligned with the at least one pocket, such as the pair of pockets 70 and 78 in the base 22. Each slot 100 can be sized and shaped to receive the both butt and tip portions 94 and 96 of the blank or shaft 86 of the fishing rod 14 when broken-down. In addition, each slot 100 can have an opening 104 in a front of the top rib 26, and a base 108 inward with respect to the opening 104, and offset with respect to the opening 104. Thus, the slot 100 can form an elbow with obtuse sections to help retain the shaft 86, or the butt and tip portions 94 and 96 thereof, in the slot 100.

Thus, the fishing rod 14 can be broken-down, and the blank or shaft 86 of the fishing pole 14 can be separated at the ferrule 90 into butt and tip portions 94 and 96, and doubled back on one another with fishing line in guides thereof. In one aspect, the handle 74 and the tip 82 of the rod 14 can be inserted into the at least one pocket. In another aspect, the handle 74 of the rod 14 can be inserted into the handle pocket 70 of the base 22, and the butt portion 94 of the blank or shaft 86 can be inserted into the slot 100 of the top rib 26. Similarly, the tip 82 of the rod 90 can be inserted into the tip pocket 78 in the base 22, and the tip portion 96 of the blank or shaft 86 can be inserted into the slot 100 of the top rib 26. Therefore, the fishing rod 14 can be broken-down to reduce the length to facilitate transportation, such as in a trunk of a car, while remaining secured in the frame 18. Thus, for each fishing rod 14, the base 22 can have a pair of pockets 70 and 78 to receive both the handle 74 and the tip 82 of the corresponding fishing pole.

Each receiver 86 and slot 100 can have a strap 112 to accompany the slot 100 in the top rib 26. Thus, each strap 112 can be associated with a corresponding slot 100 on the top rib 26. Each strap 112 can be flexible and resilient (or elastic). Each strap 112 can have a proximal fixed end 116 attached to the top rib 26 near the base 108 of the slot 100, and offset with respect to the opening 104 of the slot 100. In addition, each strap 112 can have a distal free end 118, and an array of apertures 120 along a length thereof. The apertures 120 can removably receive a hook 124 extending from the front of the base rib 26 adjacent to, and offset with respect to, the opening 104 of the slot 100. Thus, each strap 112 can have a free configuration and a fastened configuration. In the free configuration, the hook 124 is removed from an aperture 120, and the strap 112 allows access to and from the slot 100 through the opening 104 to the fishing poles 14, or blanks or shafts 86 thereof. In the fastened configuration, the hook 124 is selectively received in one of the apertures 120 of the strap 112. In addition, the strap 112 extends around the butt and tip portions 94 and 96 of the blank or shaft 86 of the fishing pole 14. Furthermore, the strap 112 can draw the butt and tip portions 94 and 96 of the blank or shaft 86 of the fishing pole 14 to the bottom 108 of the slot 100, and offset with respect to the opening 104. The straps 112 can be formed of flexible and resilient material, such as rubber or the like. The straps 112 can have a bore at the proximal fixed end 116 to receive a fastener to secure the strap 112 to the top rib 26. The distal free end 118 of the strap 112 can be enlarged to facilitate grasping.

Each slot 100 and the at least one pocket, such as the pair of pockets 70 and 78, can be paired together to form a receiver 86. The receivers 86, and the corresponding slots 100 and pockets 70 and 78, can be aligned substantially parallel with one another, and can be aligned substantially parallel with the longitudinal axis of the frame 18. In addition, the receivers 86 can be arranged in a broad arc, indicated by phantom line 122 in FIGS. 11-13. Thus, the slots 100 and the pairs of pockets 74 and 78 similarly define broad arcs 122. An axis of the broad arc 122 can also be aligned substantially parallel with the longitudinal axis 20 of the frame 18. The broad arc 122 can have a width greater than a depth. A concavity 126 is defined by the broad arc 122, and contained within a lateral perimeter of the frame 18. The concavity 126 can be oriented to open to the back of the frame 18 and to face rearward. In one aspect, the caddy 10 can carry, hold and display multiple fishing rods 14, with each fishing rod 14 located in a different one of the array of receivers 68. The receptacles 86 arrayed in a broad arc 122 can present the fishing rods 14 arrayed in a broad arc to be visually displayed, while remaining in a flat layer to facilitate transportation.

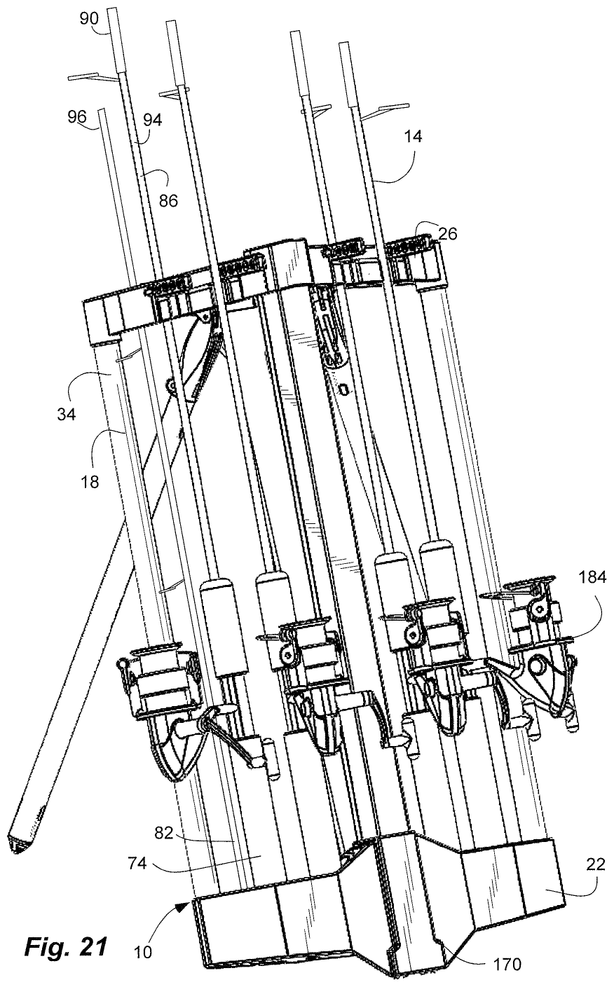

The caddy 10 and the frame 18 can also have at least one leg, such as a pair of legs 134, carried by the frame 18 and pivotal with respect to the frame 18 between retracted and deployed configurations. In the retracted configuration (FIGS. 1-11 and 13-19), the legs 134 can be oriented adjacent to the frame 18. In the deployed configuration (FIGS. 12, 16-19 and 21), the legs 134, or lower ends thereof, can be oriented to extend from the frame 18. In the deployed configuration, the legs 134 can orient the frame 18, and thus the fishing rods 14, at an incline with respect to horizontal during use or while fishing. Thus, the array of receivers 68, and thus the fishing rods 14, can be oriented at an incline. In one aspect, the legs 134 can be positioned in the concavity 126, and can be substantially enclosed in the concavity 126, of the broad arc 122 when the legs 134 is in the retracted orientation. Thus, the frame 18, and the base 22 and the top rib 26 thereof, can protect the legs 134 from inadvertently catching on other items during transportation. In addition, positioning the legs 134 in the concavity 126 allows the lateral sides of the frame 18 to be positioned closer to the support surface when the caddy 10 is mounted on the support surface.

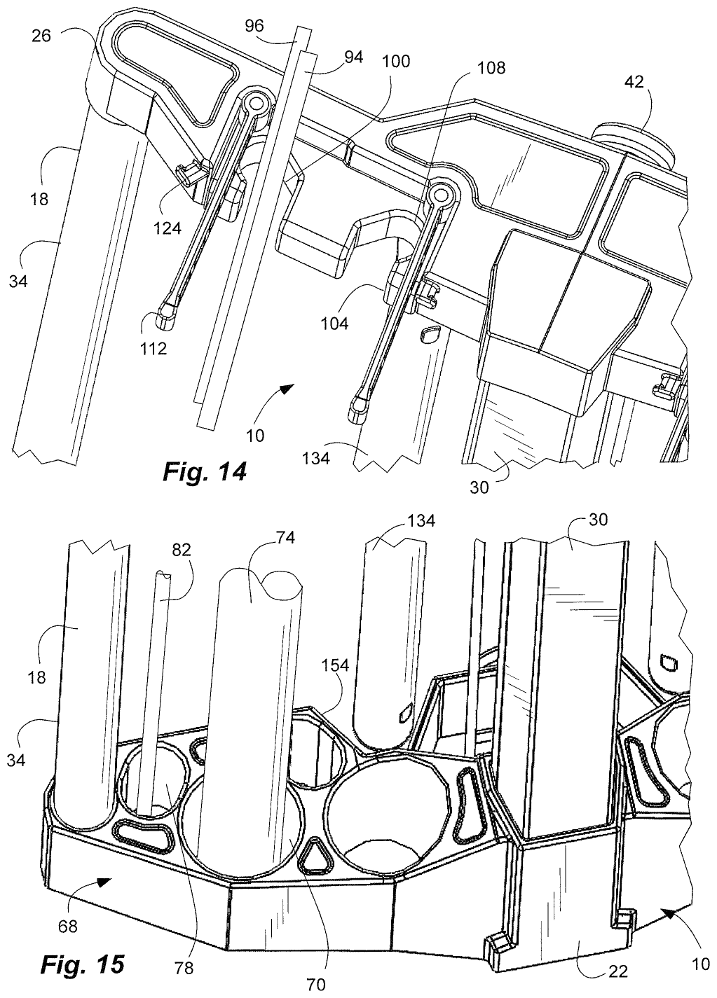

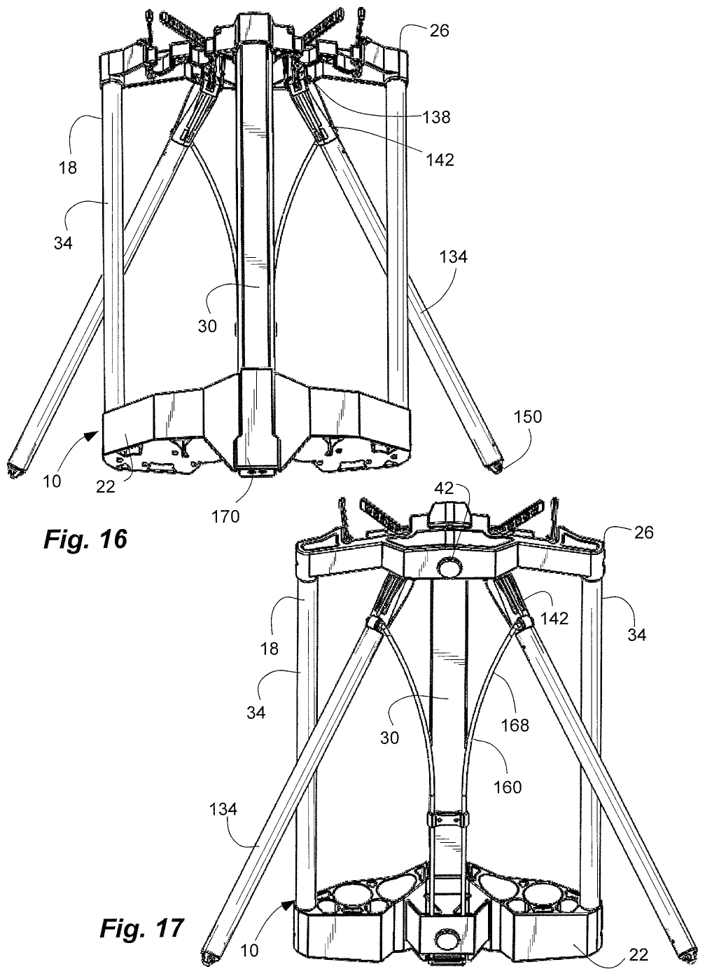

The legs 134 can each have a top end pivotally coupled to the top rib 26. In one aspect, the pair of legs 134 can be pivotally coupled at pivots 138 (FIG. 16). The pivots 138 or pivot axes thereof can be oriented at an obtuse angle with respect to one another so that a bottom and distal free end of the legs 134 are separated wider in the deployed configuration than in the retracted configuration. In one aspect, each leg 134 can comprise an upper mount 142 pivotally coupled to the top rib 26, and a tube 146 coupled to the upper mount 142. In addition, each leg 134 can further comprise a foot 150 coupled to the tube 146 at the bottom or distal free end. The foot 150 can be shaped to resist movement with a support surface. In one aspect, the foot 150 can be pointed. In another aspect, the legs 134 can be telescoping legs with adjustable length to accommodate angled terrain, such as beaches or watersides. In one aspect, the bottom or distal free end of each leg 134 can be disposed in a notch 154 (FIG. 13) in the frame 18 and the base 22, when the 134 are in the retracted configuration. The notch 154 can comprise a pair of notches 154 to receive the pair of legs 134. The notches 154 can resist the distal free ends of the legs 134 from inadvertently snagging on other objects during transportation. In one aspect, the leg 134 and the receivers 68 can be spaced-apart from the center spine 30 and the lateral spars 34 to define a center handle and a pair of lateral handles, respectively.

The legs can have an automatic deployment mechanism 160 carried by the frame 18 and operatively coupled to the legs 134 to automatically deploy the legs 134 to the deployed orientation. The automatic deployment mechanism 160 is also substantially enclosed in the concavity 126 of the broad arc 122 when the legs 134 are in the retracted orientation. A peddle or foot 164 can be pivotally coupled to the base 22 at a bottom of the frame 18. A link 168 can be pivotally coupled to and between the foot 164 and the legs 134 near a top thereof. In one aspect, the link 168 can be pivotally coupled to the upper mounts 142 of the legs 134. In one aspect, the link 168 can be a flexible and resilient wire or pair of wires. The link 168 can be a spring. The peddle or foot 164 can pivot when the frame 18 is placed on a surface and tilted backwards, displacing the link 168 and causing the legs 134 to pivot to the deployed orientation. A tab 170 can extend from the bottom of the frame 18 and the base 22 to below or at an elevation of a bottom of the foot 164 to resist the foot 164 from pivoting when the caddy 10 and the frame 18 are in a vertical orientation on the support surface. Thus, when the caddy 10 and the frame 18 are simply placed on the ground, the tab 170 contacts the ground rather than the foot 164. But when the caddy 10 and the frame 18 are placed on the ground and tilted rearward, the foot 164 contacts the ground and pivots to displace the link 168 and deploy the legs 134.

In one aspect, the hangers 42 can extend beyond the frame 18, and the hangers 42 can extend beyond the concavity 126 of the broad arc 122, and the hangers 42 can extend beyond the legs 134. Similarly, the enlarged head 54 of the lugs 50 of the hangers 42 can extend beyond the frame 18, the concavity 126 of the broad arc 122, and the legs 134. Thus, the caddy 10 and the frame 18 can be hung on the notches 46 on the support surface without interference from the frame 18 or the legs 134.

In one aspect, one or more reel separators 180 (FIG. 20) can be carried by the frame 18 and can extend between adjacent receivers 68 to separate adjacent reels 184 (FIG. 20) of adjacent fishing rods 14. In one aspect, the reel separators 180 can be removably coupled to the frame 18, such as with a snap-fit. The reel separators 180 can comprise a fin or plate located intermediate the base 22 and the top rib 26, and extending to a location between adjacent reels 184 of the fishing rods 14.

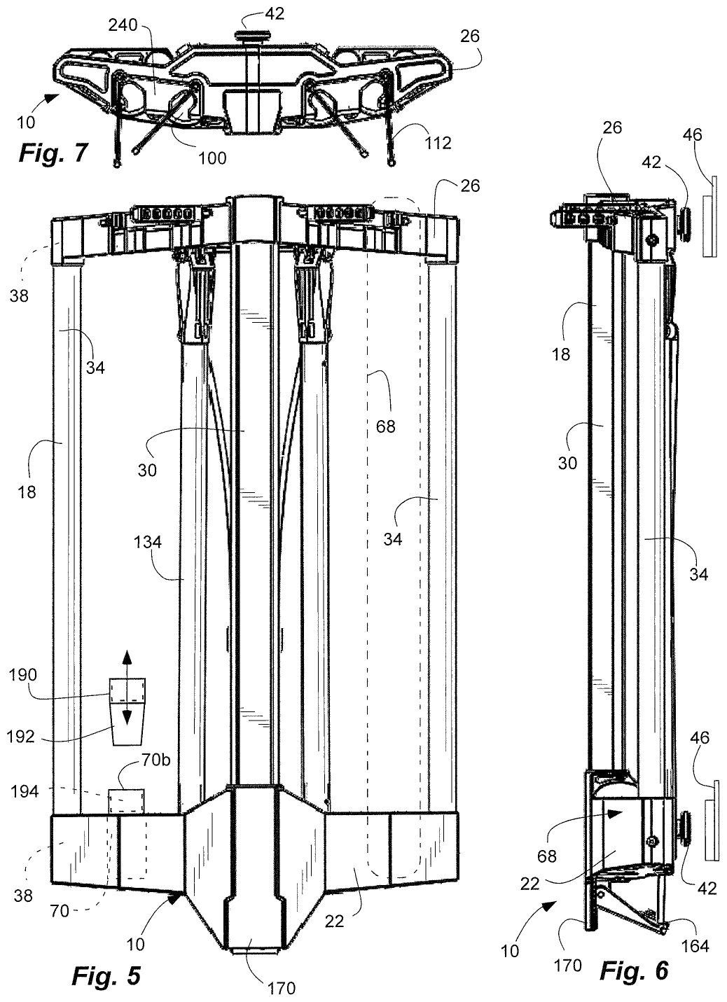

In another aspect, one or more reel height adaptors 190 (FIG. 5) can be removably and selectively installed into one or more of the handle pockets 70 to elevate a corresponding fishing rod 14 and reel 184 with respect to an adjacent fishing rod and reel with its handle in the adjacent handle pocket. Thus, adjacent fishing rods 14 are positioned at different elevations in order to vertically offset their respective reels with respect to one another. Each reel height adaptor 190 can have a tapered base 192 to fit into a handle pocket 70 and an upper cup 194 forming an elevated handle pocket 70b.

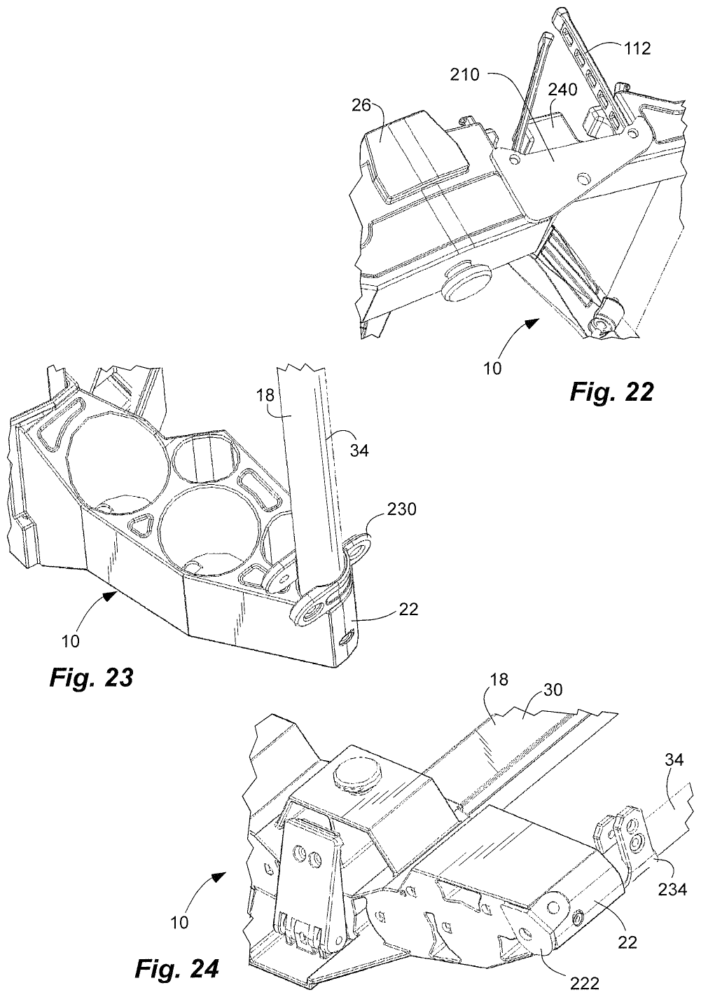

In another aspect, the frame 18 can be configured for being mounted to and carried by a backpack. Referring to FIG. 20, the notches 46 can have slots 200 to receive straps (not shown) associated with the backpack. Referring to FIGS. 22-24 various different mounting structures are shown to adapt the caddy 10 and the frame 18 to be secured to and carried by the backpack. In one aspect, the caddy 10, the frame 18 and the top rib 26 can have a top plate 210 (FIG. 22) mounted thereto and extending beyond a perimeter of the top rib 26 to provide a hole for securing to the backpack. The top plate 210 can be mounted to the top rib 26 utilizing the same fasteners as the straps 112. In another aspect, the caddy 10, the frame 18 and the base 22 can have a bottom plate 222 (FIG. 24) mounted thereto and extending beyond a perimeter of the base 22 to provide a hole for securing to the backpack. In another aspect, the caddy 10, the frame 18 and the lateral spars 34 can have clamps 230 (FIG. 23) and/or 234 (FIG. 24) mounted thereto and extending beyond the lateral spars 34 to provide a hole for securing to the backpack.

In another aspect, the caddy 10, the frame 18 and the top rib 26 can have a flexible covering around the slots 100 to better grip and protect the fishing rods. In one aspect, a bumper 240 formed of flexible material can surround the slots 100.

A method for storing, carrying and supporting multiple fishing rods 14, and for using the fishing rod caddy 10 as described above, can some or all of the following:
1) selectively attaching a first pair of notches 46 to a first support surface;
2) a selectively securing the fishing pole caddy 10 to the first support surface with a pair of hangers 50 or lugs 54 on a back thereof mating with the first pair of notches 46;
3) placing a handle 74 of a fishing rod 14 in one of the plurality of handle pockets 70 in the base 22 of the caddy 10;
4) inserting a blank or shaft 86, or butt portion 94, of the fishing rod 14 into one of the plurality of slots 100 aligned with and spaced-apart from a corresponding handle pocket 70;
5) separating the tip portion 96 of the blank or shaft 86 of the fishing rod 14 from the butt portion 94 at the ferrule 90, and doubling back the tip portion 94 on the butt portion;
6) inserting the tip portion 96 of the fishing rod 14 into the corresponding tip pocket 78 in the base 22 of the caddy 10, and inserting the tip portion 94 of the fishing rod 14 into the slot 100;
7) wrapping one of a plurality of straps 112 associated with a corresponding slot 100 around the blank or shaft 86, or butt portion 94 and tip portion 96, of the fishing rod 14 and securing the strap 112 taut against the blank or shaft 86, or the butt portion 94, of the fishing pole 14;
8) removing the caddy 10 from the support surface with the fishing rod 14 therein;
9) carrying the caddy 10 with the fishing rod 14 therein to another location;
10) placing the caddy 10 with the fishing rod 14 therein in a vehicle;
11) placing the caddy 10 with the fishing rod 14 therein on the ground and causing the pair of legs 134 to deploy;
12) lifting the caddy 10 from the ground and causing the pair of legs 134 to retract;
13) returning the caddy 10 with the fishing rod 14 therein to the first support surface.

In one aspect, the support surface can include at least one of a wall, a ceiling, a trunk of a vehicle, a bed of a vehicle, a boat, a backpack, a tackle box, a cooler or ice chest. In another aspect, the caddy 10 can be oriented in an orientation comprising at least one of a vertical, a horizontal or an inclined orientation.

In another aspect, the method can further comprise: selectively securing the fishing pole caddy 10 to a second support surface, different from and remote from the first support surface, with the pair of receivers 42 mating with a second pair of notches 46.

In another aspect, the method can further comprise:
a) separating butt and tip portions 94 and 96 of the blank or shaft 86 of the fishing pole 14 at a ferrule 90;
b) doubling back the tip portion 96 of the blank or shaft 86 alongside the butt portion 94;
c) inserting a tip 82 of the tip portion 96 of the fishing pole 14 into one of a plurality of tip receptacles 78 of the device 10 corresponding to the one of the handle receptacles 70; and
d) wrapping the one of the plurality of straps 112 around both the butt and the tip portions 94 and 96 of the blank or shaft 86 of the fishing pole 14 and securing the strap 112 taut against the both the butt and the tip portions 94 and 96 of the blank or shaft 86 of the fishing pole 14.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A fishing rod caddy configured to carry fishing rods, the caddy comprising:
a) a frame;
b) an array of receivers carried by the frame and each sized and shaped to receive a fishing rod;
c) at least one leg carried by the frame and pivotal with respect to the frame between a retracted orientation adjacent the frame and a deployed orientation extending from the frame configured to orient the frame at an incline with respect to horizontal; and
d) an automatic deployment mechanism carried by the frame and operatively coupled to the at least one leg to automatically deploy the at least one leg to the deployed orientation, the automatic deployment mechanism comprising:
i) a foot pivotally coupled to the frame at a bottom thereof;
ii) a link coupled to and between the foot and the at least one leg near a top thereof; and
iii) the foot pivoting when the frame is placed on a surface and tilted backwards, displacing the link and causing the at least one leg to pivot to the deployed orientation.

2. The rod caddy in accordance with claim 1, further comprising:
a tab extending from the bottom of the frame below or at an elevation of a bottom of the foot and configured to resist the foot from pivoting when the frame is in a vertical orientation on the support surface.

3. The rod caddy in accordance with claim 1, further comprising:
a) the frame comprising a base and a top rib spaced-apart from the base;
b) the at least one leg being pivotally coupled to the top rib, and having a free distal end disposed in a notch in the base when the at least one leg is in the retracted orientation.

4. The rod caddy in accordance with claim 1, further comprising:
a) the frame comprising opposite lateral sides;
b) the array of receivers arranged in a broad arc with distal ends of the broad arc located adjacent the opposite lateral sides of the frame;
c) a concavity defined by the broad arc;
d) the at least one leg being substantially enclosed in the concavity of the broad arc when the at least one leg is in the retracted orientation; and
e) the automatic deployment mechanism being substantially enclosed in the concavity of the broad arc when the at least one leg is in the retracted orientation.

5. The rod caddy in accordance with claim 4, further in combination with a plurality of fishing rods, each fishing rod located in a different one of the array of receivers; the plurality of fishing rods being arrayed in a broad arc.

6. The rod caddy in accordance with claim 1, further comprising:
a) at least one hanger carried by the frame and configured to suspend the frame pendent therefrom; and
b) the at least one hanger extending beyond the concavity and the at least one leg.

7. The rod caddy in accordance with claim 6, further in combination with a support surface; and the hanger comprising:
a) at least one notch secured to the support surface and comprising a pocket with a narrower slot open to an enlarged cavity; and
b) at least one lug extending from the frame and having an enlarged head spaced-apart from the frame by a narrower neck, and being removably receivable in the at least one notch with the narrower slot receiving the neck of the lug and the enlarged cavity receiving the head the lug; and
c) the enlarged head of the at least one lug extending beyond the at least one leg.

8. The rod caddy in accordance with claim 1, further comprising:
a) the frame comprising a base and a top rib spaced-apart from the base;
b) each receiver comprising:
i) a slot in the top rib;
ii) the slot being sized and shaped to receive both butt and tip portions of the fishing rod when the shaft of the fishing rod is separated at a ferrule into the butt and tip portions and doubled back on one another;
iii) at least one pocket in the base and corresponding to the slot in the top rib; and
iv) the at least one pocket being sized and shaped to receive a handle of the fishing rod and a tip of the fishing rod when the shaft of the fishing rod is separated at the ferrule into the butt and the tip portions and doubled back on one another.

9. The rod caddy in accordance with claim 8, wherein the at least one pocket of each receiver further comprises:
a) a pair of pockets located adjacent one another in the base and the pair of pockets corresponding to the slot in the top rib;
b) the pair of pockets comprising a handle pocket and a tip pocket; and
c) the handle pocket being sized and shaped to receive the handle of the fishing rod, and the tip pocket being sized and shaped to receive the tip of the fishing rod, when the shaft of the fishing rod is separated at the ferrule into the butt and tip portions and doubled back on one another.

10. The rod caddy in accordance with claim 1, wherein the frame further comprises:
a) a base;
b) a top rib spaced-apart from the base;
c) a center spine coupled to and extending between the base and the top rib;
d) a pair of lateral spars coupled to and extending between the base and the top rib, each on a different lateral side; and
e) the at least one leg and the array of receivers being spaced-apart from the center spine and the pair of lateral spars to define a center handle and a pair of lateral handles, respectively.

11. A fishing rod caddy configured to carry fishing rods, the caddy comprising:
a) a frame with a base and a top rib spaced-apart from the base;
b) an array of receivers carried by the frame and each sized and shaped to receive a fishing rod;
c) each receiver comprising:
i) a slot in the top rib;
ii) the slot being sized and shaped to receive both butt and tip portions of the fishing rod when the shaft of the fishing rod is separated at a ferrule into the butt and tip portions and doubled back on one another;
iii) at least one pocket in the base and corresponding to the slot in the top rib; and
v) the at least one pocket being sized and shaped to receive a handle of the fishing rod and a tip of the fishing rod when the shaft of the fishing rod is separated at the ferrule into the butt and tip portions and doubled back on one another.

12. The rod caddy in accordance with claim 11, wherein the at least one pocket of each receiver further comprises:
a) a pair of pockets located adjacent one another in the base and the pair of pockets corresponding to the slot in the top rib;
b) the pair of pockets comprising a handle pocket and a tip pocket; and
c) the handle pocket being sized and shaped to receive the handle of the fishing rod, and the tip pocket being sized and shaped to receive the tip of the fishing rod, when the shaft of the fishing rod is separated at the ferrule into the butt and tip portions and doubled back on one another.

13. The rod caddy in accordance with claim 11, further comprising:
a) at least one leg carried by the frame and pivotal with respect to the frame between a retracted orientation adjacent the frame and a deployed orientation extending from the frame configured to orient the frame at an incline with respect to horizontal; and
b) an automatic deployment mechanism carried by the frame and operatively coupled to the at least one leg to automatically deploy the at least one leg to the deployed orientation, the automatic deployment mechanism comprising:
i) a foot pivotally coupled to the frame at a bottom thereof;
ii) a link coupled to and between the foot and the at least one leg near a top thereof; and
iii) the foot pivoting when the frame is placed on a surface and tilted backwards, displacing the link and causing the at least one leg to pivot to the deployed orientation.

14. The rod caddy in accordance with claim 13, further comprising:
a tab extending from the bottom of the frame below or at an elevation of a bottom of the foot and configured to resist the foot from pivoting when the frame is in a vertical orientation on the support surface.

15. The rod caddy in accordance with claim 13, further comprising:
the at least one leg being pivotally coupled to the top rib, and having a free distal end disposed in a notch in the base when the at least one leg is in the retracted orientation.

16. The rod caddy in accordance with claim 13, further comprising:
a) the frame comprising opposite lateral sides;
b) the array of receivers arranged in a broad arc with distal ends of the broad arc located adjacent the opposite lateral sides of the frame;
c) a concavity defined by the broad arc;
d) the at least one leg being substantially enclosed in the concavity of the broad arc when the at least one leg is in the retracted orientation; and
e) the automatic deployment mechanism being substantially enclosed in the concavity of the broad arc when the at least one leg is in the retracted orientation.

17. The rod caddy in accordance with claim 16, further in combination with a plurality of fishing rods, each fishing rod located in a different one of the array of receivers; the plurality of fishing rods being arrayed in a broad arc.

18. The rod caddy in accordance with claim 11, further comprising:
a) at least one hanger carried by the frame and configured to suspend the frame pendent therefrom; and
b) the at least one hanger extending beyond the frame.

19. The rod caddy in accordance with claim 18, further in combination with a support surface; and the hanger comprising:
a) at least one notch secured to the support surface and comprising a pocket with a narrower slot open to an enlarged cavity; and
b) at least one lug extending from the frame and having an enlarged head spaced apart from the frame by a narrower neck, and being removably receivable in the at least one notch with the narrower slot receiving the neck of the lug and the enlarged cavity receiving the head the lug; and
c) the enlarged head of the at least one lug extending beyond the at least one leg.

20. The rod caddy in accordance with claim 11, wherein the frame further comprises:
a) a center spine coupled to and extending between the base and the top rib;
b) a pair of lateral spars coupled to and extending between the base and the top rib, each on a different lateral side; and
c) the at least one leg and the plurality of receivers being spaced-apart from the center spine and the pair of lateral spars to define a center handle and a pair of lateral handles, respectively.

21. A fishing rod caddy configured to carry fishing rods, the caddy comprising:
a) a frame with opposite lateral sides, the frame comprising:
i) a base;
ii) a top rib spaced-apart from the base;
iii) a center spine coupled to and extending between the base and the top rib; and
iv) a pair of lateral spars coupled to and extending between the base and the top rib, each on a different lateral side;
b) an array of receivers carried by the frame and each sized and shaped to receive a fishing rod, each receiver comprising:
i) a slot in the top rib;
ii) the slot being sized and shaped to receive both butt and tip portions of the fishing rod when the shaft of the fishing rod is separated at a ferrule into the butt and tip portions and doubled back on one another;
iii) a pair of pockets located adjacent one another in the base with the pair of pockets corresponding to the slot in the top rib;
iv) the pair of pockets comprising a handle pocket and a tip pocket; and
v) the handle pocket being sized and shaped to receive a handle of the fishing rod and the tip pocket being sized and shaped to receive a tip of the fishing rod when the shaft of the fishing rod is separated at the ferrule into the butt and the tip portions and doubled back on one another;
c) the array of receivers arranged in a broad arc with distal ends of the broad arc located adjacent opposite lateral sides of the frame with the plurality of slots of the plurality of receivers defining a broad arc in the top rib, and with the plurality of pairs of pockets of the plurality of receivers defining a broad arc in the base;
d) a concavity defined by the broad arc of the plurality of receivers;
e) at least one leg carried by the frame and pivotal with respect to the frame between a retracted orientation adjacent the frame and a deployed orientation extending from the frame configured to orient the frame at an incline with respect to horizontal;
f) the at least one leg being substantially enclosed in the concavity of the broad arc when the at least one leg is in the retracted orientation; and
g) the at least one leg and the plurality of receivers being spaced-apart from the center spine and the pair of lateral spars to define a center handle and a pair of lateral handles, respectively.

22. The rod caddy in accordance with claim 21, further comprising:
a) a pair of hangers configured to be disposed between and intercoupling the frame and the support surface to suspend the frame pendent from the support surface, each hanger comprising:
i) at least one notch configured to be secured to the support surface and comprising a pocket with a narrower slot open to an enlarged cavity;
ii) at least one lug with an enlarged head spaced apart from the frame by a narrower neck, and being removably receivable in the at least one notch with the narrower slot receiving the neck of the lug and the enlarged cavity receiving the head the lug; and
iii) the enlarged head of the at least one lug extending beyond the at least one leg; and
b) the pair of hangers being positioned to selectively orient the array of receptacles, and configured to selectively orient the fishing rods, in a vertical orientation, or a horizontal orientation, or at an acute incline.
